(19) United States
(12) Patent Application Publication
(10) Pub. No.: US 2026/0214026 A1
(43) Pub. Date: Jul. 23, 2026

(54) NETWORK DIAGRAM LAYOUT GENERATOR

(71) Applicant: Cisco Technology, Inc., San Jose, CA (US)

(72) Inventor: Hugh Hamill, Galway (IE)

(21) Appl. No.: 19/028,817

(22) Filed: Jan. 17, 2025

(51) Int. Cl. H04L 41/22; H04L 41/16

(52) U.S. Cl. CPC H04L 41/22; H04L 41/16

(57) ABSTRACT

Techniques presented herein generate network visualization(s), such as network topology graphs, in which placement and representation of network components are predicted to mimic users' behavior in a design process. Methods are provided that involve obtaining network topology information including a plurality of attributes related to at least two network devices in a network and generating a plurality of predictions based on the network topology information. The plurality of predictions mimic a user specific placement and a visual representation for each of the at least two network devices. The methods further involve generating a network visualization that includes at least two network components representing the at least two network devices on a canvas, based on the plurality of predictions and providing the network visualization for changing a configuration of the network in a real networking environment or for simulating or emulating operations of the network in a virtual environment.

### TECHNICAL FIELD

The present disclosure relates to network simulation tools and services.

### BACKGROUND

Network configuration and management are not easy tasks. These tasks are even more difficult for users of networks with increasing complexities. To help users, many software solutions provide visual guides. For example, software solutions may include network topology graphs for visualizing components of the network and their connections. These network topology graphs may be used to control computer networks and/or simulate a network environment for testing and troubleshooting. Typically, these topology graphs are user designed. For example, users may manually interact with a tool to place icons representing network components (virtual machines, hardware items, network controllers, etc.) in a logical layout on a canvas, thus creating a network topology graph. This approach, however, is time consuming. Moreover, with increased network complexities, this approach is prone to human errors.

### BRIEF DESCRIPTION OF THE DRAWINGS

FIG. 1A is a block diagram depicting a system in which a network visualization generator is deployed to generate network visualizations that mimic user specific component placements and representations within a network environment, according to an example embodiment.

FIG. 1B is a diagram depicting a user interface screen for providing network visualizations, generated by the network visualization generator of FIG. 1A and for configuring networks and/or running network simulations, according to an example embodiment.

FIG. 2 is a diagram depicting phases including a training phase in which the network visualization generator of FIG. 1A is trained to mimic user specific design behavior and an operating phase in which the network visualization generator of FIG. 1A is configured to generate predictions about user specific placement and visual representation for each component of a network visualization, according to an example embodiment.

FIG. 3 is a diagram depicting components of the network visualization generator of FIG. 1A, according to an example embodiment.

FIG. 4 is a comparative view illustrating a network topology diagram in which a few network components are visually represented and placed at locations that resemble user behavior using techniques presented herein as opposed to representations and locations for these network components using conventional techniques.

FIG. 5 is a flowchart illustrating a method of generating and providing a network visualization for changing a configuration of the network in a networking environment, according to an example embodiment.

FIG. 6 is a hardware block diagram of a computing device that may perform functions associated with any combination of operations in connection with the techniques depicted and described in FIGS. 1A, 1B, 2, 3, 4 and 5, according to various example embodiments.

### DETAILED DESCRIPTION

### Overview

Techniques presented herein generate network visualization(s) such as network diagrams and network topology graphs in which placement and representation of network components are predicted by an artificial intelligence (AI) or machine learning (ML) model to mimic users' behavior in a design process.

In one form, methods are provided that involve obtaining network topology information including a plurality of attributes related to at least two network devices in a network and generating a plurality of predictions based on the network topology information. The plurality of predictions mimic a user specific placement and a visual representation for each of the at least two network devices. The methods further involve generating a network visualization that includes at least two network components representing the at least two network devices on a canvas, based on the plurality of predictions and providing the network visualization for changing a configuration of the network in a real networking environment or for simulating or emulating operations of the network in a virtual environment.

### Example Embodiments

There are many software platforms for controlling computer networks or virtual computer networks. These software platforms may enable operators, engineers, network designers, network architects, and/or other users to design, configure, troubleshoot, run simulations, and/or emulate network environment(s). These software platforms typically use network visualizations i.e., visual representations that depict network(s) and/or network environment(s). Network visualizations depict the network and its components in a form of a graph, a map, a tree-structure, etc. These network visualizations help users perform various network related tasks. By way of an example, network visualizations may be network diagram layouts and/or network topology graphs or trees.

Specifically, in a real networking environment, users may rely on network visualizations to configure or change configurations of the network, including configurations of network devices and links/connections between network devices. Network visualization may depict a network problem, such as a latency issue, a failed connection, a security vulnerability, etc. Additionally, users may interact with network visualizations to troubleshoot and/or fix a network problem. For example, users may reconfigure a network device to, for example, use a different port to reduce latency, connect to a different network device to avoid a failed connection, change a source address of the network device to address a security vulnerability, etc. These configuration actions may be performed directly on network visualizations by interacting with network components depicted on a canvas.

As another example, in a simulated or emulated network environment, users may design a network and predict its characteristics such as delays, coverages, etc. Users may interact with network visualizations to test the network, validate the network and/or its configurations. Users may interact with network visualizations to troubleshoot a network that is deployed or about to be deployed using simulations. While network visualizations (network topology maps, diagrams, graphs, and other layouts) may help users understand network complexities, their design can be a tedious process.

The design process typically involves manual user interactions in which icons representing network components (virtual machines, hardware items, network controllers, etc.) are “dragged and dropped” in a logical layout on a canvas. For example, if no deliberate layout is selected, as the user adds nodes to the canvas, these nodes stack up on top of each other i.e., these nodes are placed in the same default location. The user may then use a mouse to physically drag the nodes to different locations on the canvas to spread them out. It can take a long time for users to design these network visualizations, especially for large networks such as enterprise networks. Additionally, users may need special training to design these network topologies or diagrams but even skilled and experienced users may make mistakes.

To help with the design process, some software platforms may include layout tools which help create a network diagram. The layout tools may provide a canvas on which users place nodes in a tree layout or an Fruchterman-Reingold (F-R) layout. A basic tree layout may allow users to select a network node as the root of the tree, and the nodes connected to the root become the children of that root node. An F-R layout has connected nodes close to each other, while unconnected nodes are further apart from each other. These software platforms may include graphing libraries and tools that use a layout algorithm such as a “force-directed” algorithm to mathematically calculate the layout with the most even spread that avoids excessive overlapping. This results in a “spread out” graph. In other words, layout tools typically use mathematical algorithms to generate topology graphs. As such, the nodes are typically aligned with one another and are evenly spaced out. However, at times, such an approach is not desirable. Network engineers and architects may have their own specific habits when designing network diagrams. Mathematically based algorithms do not account for user specific habits and design behavior.

Additionally, skilled users may prefer a different approach to creating a network visualization depending on their skill level, design methodology, etc. For example, evenly spread out nodes at even angles around a central point may be considered counter intuitive in a network topology diagram. Instead, nodes such as virtual machines (VMs) tend to be clustered above, below, or around a network on a canvas. While nodes in the network topology may be aligned horizontally or vertically, these nodes are spread apart or spread out unevenly. Moreover, one user may cluster nodes unevenly together around a depicted network on the canvas based on one attribute (e.g., a primary function of the devices), while another user may use another attribute (e.g., a connection type—virtual, physical, wired, wireless, etc.) to cluster nodes unevenly together around the network on the canvas. In short, expert created network visualizations may include connected network components on the canvas being unevenly spaced apart and/or unevenly clustered together on the canvas, based on user's design methodology (to resemble user specific placement) e.g., not a strictly mathematical design. The terms “canvas” and “2D canvas” are used interchangeably herein and are meant to refer to a container for drawing elements like line, shapes, and text for a network graph or diagram. These terms provide a platform or a user interface for organizing and designing logical or virtual representations of components of a network such as network devices, computing devices, networks, and/or links.

The techniques presented herein learn user(s) behavior (design methodology) and mimic learned behavior in generating network visualizations e.g., by training an artificial intelligence (AI) or a machine learning (ML) model. Techniques presented herein provide a network visualization generator, that is, a topology view generator and modeling tools that use ML/AI models to learn users' design methodology such as device placements, visual representations (icon types), and other attributes to generate a customized network visualization. For example, a customized network topology is generated in which placement and visual representation of the nodes are specific to user(s) design methodology. In other words, the placement and visual representation mimics and resembles user specific behavior. In short, one or more ML or AI models generate placement predictions based on network topology information.

The network visualization (network topology) may then be provided for validation, testing, and/or troubleshooting of a deployed or to be deployed network. For example, performance of a network may be evaluated and optimum configuration for the network may be generated to configure a predetermined number of network devices, configure each network device with certain characteristics/attributes (limit signal strength, orientation, number, length, and type of connections), etc.

Also, the techniques presented herein configure a network and/or resolve a network problem based on interactions with a network visualization, which is generated more efficiently, faster, and automatically. That is, network components are designed on a canvas in way that mimics user placement and/or visual representation. Since these network visualization are automatically generated (without user involvement), the network visualization is accurate (avoids human errors) and is generated faster. As an additional benefit, an inexperienced user (without knowledge of design methodologies) may use the techniques presented herein to generate network topology layouts that experienced and skilled users would generate (that resembles diagrams generated by experienced and seasoned network designers).

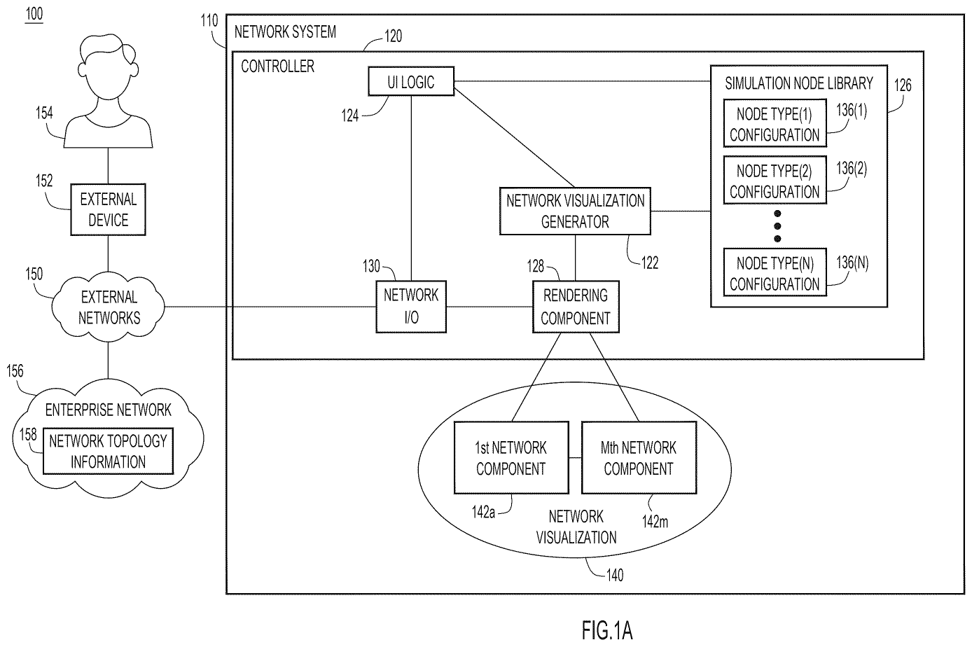

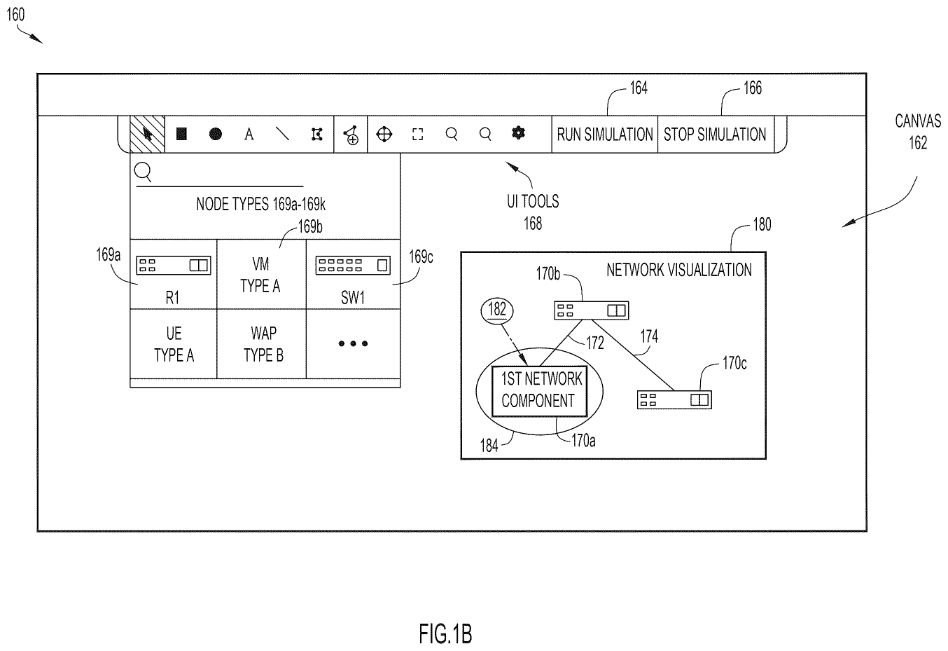

Referring first to FIG. 1A, a block diagram is shown depicting a system 100 in which a network visualization generator is deployed to generate network visualizations that mimic user specific component placements and representations within a network environment, according to an example embodiment. FIG. 1B is a diagram depicting a user interface for providing network visualizations generated by the network visualization generator and for configuring networks and/or running network simulations, according to an example embodiment. FIG. 1B is discussed in relation to features discussed for FIG. 1A.

As shown in FIG. 1A, the system 100 may include a network system 110. The network system 110 may include a controller 120 using in which network visualizations may be generated for running network simulations and/or configuring network devices and monitoring operations thereof in the real networking environment. In one example embodiment, the controller 120 may be one or more computing devices (e.g., server(s)). The controller 120 may include a network visualization generator 122, a user interface logic (UI logic 124), a node library 126, a rendering component 128, and network input/output (I/O) interfaces, shown in FIG. 1A as network I/O 130. Network I/O 130 is also referred to interchangeably herein as an ethernet hardware interface element.

The network visualization generator 122 generates network topology diagrams or graphs, shown as a network visualization 140. In some instances, the network visualization 140 may be a network simulation (a “lab” or a “modeling lab”). Users may interact with the network visualization generator 122 using the UI logic 124. Using the UI logic 124, users may add a new network device to a network or reconfigure an existing network device.

Node library 126 may include configuration or network topology information (attributes) that defines a number of different types of nodes that can be incorporated into a given network in which each of the nodes may be associated with a certain type of network device, such as an access point, user equipment, a client device, a switch, a router, a gateway, an optical transmit/receive module, a load balancer, an authentication element, a network interface card, including any variations thereof (e.g., 4-port, 8-port, etc.) and/or any other type of network element that may be utilized within a network. In at least one example embodiment, a node type(1) configuration 136(1) can be provided for a first type of node such as a network device (a router or an access point), a node type(2) configuration 136(2) can be provided for a second type of node (a client device or a virtual machine), and so on for any ‘N’ types of nodes (node type(N) configuration 136(N)).

The notations 1, 2, 3 . . . n; a, b, c, . . . n; “a-n”, “a-d”, “a-f”, “a-g”, “a-k”, “a-c”, and the like illustrate that the number of elements can vary depending on a particular implementation and is not limited to the number of elements being depicted or described. Moreover, this is only examples of various components, and the number and types of components, functions, etc. may vary based on a particular deployment and use case scenario.

Broadly, a node configuration for a given type of node, as provided for/included within node library 126, can define default parameters or attributes, and/or operational behavior for the given type of node. When a particular instance of a given type of node is included in a particular network visualization, additional parameters or attributes can be configured for the particular node instance, including, but not limited to, an Internet Protocol (IP) address, service set identifier (SSID), media access control (MAC) address, frequency range, transmit power, antenna type, number of antennas, signal strength, connectivity profile, size and shape of area coverage (dimensions), etc. and, in accordance with example embodiments herein, one or more actions may be performed on behalf of the particular node instance in the particular network.

The rendering component 128 is configured to render or output the network visualization 140 generated by the network visualization generator 122. The rendering component 128 may output the network visualization 140 of components 142a-142m of the network visualization on a user interface screen and/or to a simulation tool.

The network I/O 130 may be configured as one or more Ethernet port(s), Fiber Channel ports, any other I/O port(s) now known or hereafter developed and may include and/or interface with one or more the network processor units (not shown) provided for the controller 120 to provide any suitable interfaces for receiving, transmitting, and/or otherwise communicating data and/or information within the system 100.

As shown in FIG. 1A, the network system 110 can interface, via one or more external networks 150, with one or more external devices such as an external device 152 being manipulated by a user 154. The network system 110 may also interface, via one or more external networks 150, with an enterprise network 156 that generates network topology information 158.

The network visualization generator 122, the UI logic 124, the node library 126, the rendering component 128, and the network I/O 130 may interface and operate together in any appropriate manner to facilitate configuring and operating components 142a-142m of the network visualization 140, by one or more users, such as the user 154 via the external device 152, in accordance with example embodiments herein. These components are one non-limiting example of the network system 110.

By way of an example, the user 154 may select to add a first virtual machine and a second virtual machine to a default network represented as a first network component 142a and an m^{th} network component 142m in the network visualization 140. That is, the user 154 interacts with the network system 110 via the external device 152 (e.g., a computing device, such as a laptop, desktop computer, or the like) to design or modify the network visualization 140 and/or to perform certain operations on the network components 142a-142m in the network visualization 140. In case of simulation or emulation of operations of the enterprise network 156, the user 154 may provide the network topology information 158 via the external device 152. By way of yet another example, the user 154 may indicate one or more network devices to be added/deleted/reconnected in the enterprise network 156 by interacting with the network system 110, as shown in FIG. 1B.

Additionally, performance of the enterprise network 156 may be monitored using the network system 110. That is, the network system 110 may monitor performance of the enterprise network 156 in a real networking environment and/or may troubleshoot the enterprise network 156 in the real networking environment (e.g., in real-time based on telemetry data such as the network topology information 158 from the network controller (not show)).

Further, operations of the enterprise network 156 may be evaluated using the network system 110. That is, the network system 110 may evaluate operations of the enterprise network 156 using simulations. Simulations may involve validating the enterprise network 156 for deployment, testing performance of the enterprise network 156, and/or troubleshooting the enterprise network 156 (or portions thereof) based on determined characteristics to identify and fix latency issues, avoid interferences, etc. For example, using the network system 110, signal attenuation characteristics of the devices in the enterprise network 156 may be determined to configure actual device(s) in the enterprise network 156 and/or to reconfigure the monitored devices in the enterprise network 156.

In short, the network system 110 obtains the network topology information 158 and generates one or more network visualizations. The network topology information 158 includes attributes, parameters, and characteristics of the enterprise network 156 that is to be deployed (for simulation) or is deployed (real networking environment). The network topology information 158 includes attributes of various components in the enterprise network 156. For example, the network topology information 158 includes data about network devices and their connections such as device types (router, leaf switch, access point, virtual machine, a gateway, etc.), their groupings (e.g., layer 2, layer 3, etc.), and connections to other network devices.

The network visualization generator 122 generates the network visualization 140 having network components 142a-142m, as shown in FIG. 1A or a network visualization 180 having network components 170a-170c, as shown in FIG. 1B, based on the network topology information 158.

As an example, in FIG. 1B, a UI screen 160 depicts a deployed network with various UI elements that may represent tools for monitoring performance and troubleshooting the network in a real networking environment (during runtime). In one example embodiment, the controller 120 may select instances of various node types 170a-170k based on analyzing the network topology information 158 to generate simulations. Specifically, FIG. 1B depicts the UI screen 160 for providing network visualizations generated by the network visualization generator 122 of FIG. 1A and for configuring network(s) such as the enterprise network 156.

As generally illustrated in FIG. 1B, configuration and operation of a given network, including a network simulation, may involve a user, such as the user 154, using a control bar on the canvas 162 that includes various UI elements such as a run simulation button 164, a stop simulation button 166, and other UI tools 168 to design a network topology diagram or graph (an identity or type of a network device), shown in a form of the network visualization 180.

Users may select to run a simulation (the run simulation button 164) or to stop a simulation (the stop simulation button 166) to determine performance characteristics of the network, such as evaluate operation of network components 170a-c depicted in the network visualization 180. The run simulation button 164 and the stop simulation button 166 are examples of UI elements, and other UI elements are within the scope of this disclosure. For example, using the other UI tools 168, users may select instances of various node types 169a-169k on the canvas 162 to generate or modify the network visualization 180.

Specifically, the user may drag and drop an instance of a given node type into a workspace user interface, such as the canvas 162 of the UI screen 160, which can be facilitated via the UI logic 124 of the controller 120 in FIG. 1A. The user selects a first node type 169a such as a virtual machine (VM) type A. The first node type 169a may be “drag and dropped” into the network visualization 180 at a first location 182. The network visualization generator 122 analyzes attributes of the first node type 169a, generates the first network component 170a, and moves the first network component 170a to a second location 184 in the network visualization 180. Additionally, the network visualization generator 122 may generate one or more connections 172 to connect the first network component 170a to a second network component 170b (a router) that is generated from a router node type 169b. The router may may also be connected to yet another network component 170c (a switch), via a connection 174. The switch is generated from a switch node type 169c. An identity of the network device varies based on a selected node type.

Consider an illustrative example of configuring and operating a network simulation, such as for configuring and operating the network using network visualization 180. The example regarding network visualization 180 is provided for illustrative purposes only and is not meant to limit the broad scope of example embodiments herein. For example, multiple visualizations may be provided on the canvas 162. Some network visualizations may relate to network management including monitoring a network by providing operating state indicators indicative of network problem(s) in network device(s), troubleshooting by changing configuration of network device(s) to solve network problem(s), and running simulations for performance of a network by, for example, changing appearance of nodes on a canvas to indicate network problem(s) are resolved (fully or partially).

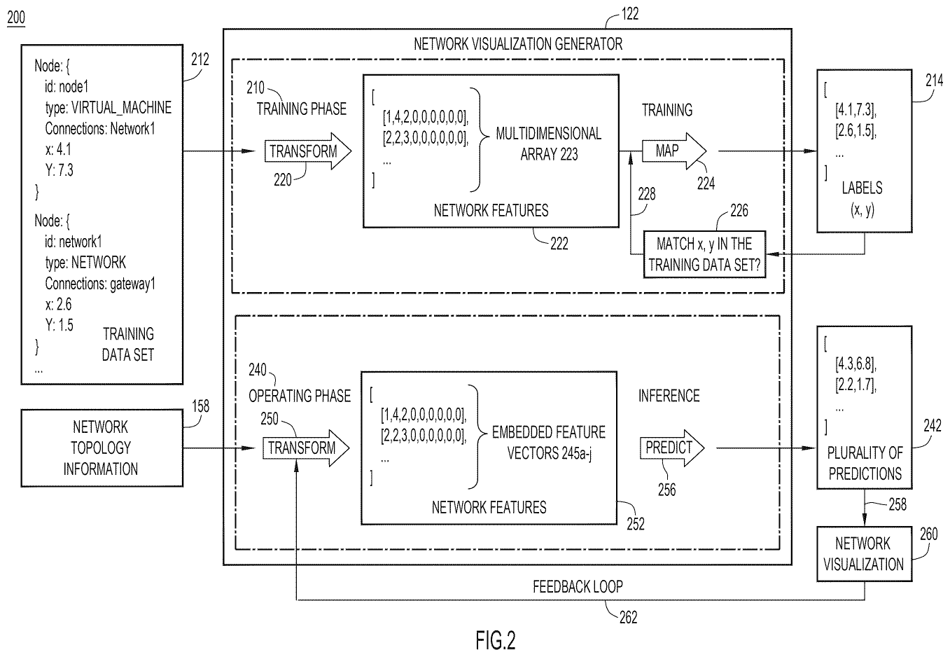

With continued reference to FIGS. 1A and 1B, reference is now made to FIG. 2. FIG. 2 is a diagram depicting phases 200 that include a training phase 210 in which the network visualization generator 122 is trained to mimic user specific design behavior and an operating phase 240 in which the network visualization generator 122 is configured to generate predictions about user specific placement and visual representation for each component of a network visualization, according to an example embodiment.

In the training phase 210, the network visualization generator 122 obtains a training data set 212, as input, and learns to accurately predict labels 214 such as placement labels (x and y coordinates on a canvas) and visual representation labels (icon types). In the operating phase 240, the network visualization generator 122 obtains network topology information 158, as input, and generates a plurality of predictions 242 that mimic user specific placement and/or visual representation for each device in the network based on the network topology information 158.

Specifically, in the training phase 210, the network visualization generator 122 is trained to learn user specific behavior and to determine user specific placement and visual representations for each device/asset of the network. The network visualization generator 122 is trained based on the training data set 212 to output the labels 214. The training data set 212 includes a plurality of existing network visualizations. For example, the training data set 212 may include network topology diagrams indicative of user specific behavior. The training data set 212 may include network topology diagrams prepared by the user and/or network topology diagrams prepared by skilled users such as network engineers.

The network visualizations in the training data set 212 may depend on a user type and preferences. If the user prefers to have individualized, custom network visualizations that are specific to their individual behavior, the training data set 212 includes only user designed network visualizations. On the other hand, if a novice user prefers to have network visualizations that mimic or resemble designs of experienced users, the training data set 212 includes network visualizations generated by expert users.

In yet another example embodiment, the network visualization generator 122 may be trained using different data sets depending on a user type. For example, the network visualization generator 122 may generate and output different network visualizations for the same network topology information based on the user type, such as a first network layout for a network operator, a second network layout for a network designer and a third network layout for a network security specialist. The first network layout, second network layout and third network layout are different from each other in one more respects.

In one or more example embodiments, the training data set 212 may include: (a) a node identifier, such as node 1 or network 1;
(b) a node type, such as a virtual machine or a network;
(c) connections, such as connected to “network 1” or “gateway 1′” and
(d) location coordinates for the canvas, such as x coordinates (e.g., 4.1 or 2.6) and y coordinates (e.g., 7.3 or 1.5).

The training data set 212 is just one non-limiting example. The training data set 212 may further include a specific icon or representation for the node type, dimensions for the connections such as connection lengths and width, allowed connection overlaps, solid lines for active connections, dotted lines for failed connections, different colors for congested connections (levels of congestions are depicted with different shades of the same color), etc. In other words, attributes of the network defined in the training data set 212 depend on a particular deployment and use case scenario.

In one or more example embodiments, the network visualization generator 122 is a neural network that is trained using the following extracted network features for each node on the canvas:
(1) The “Type” of node, e.g., virtual machine, a network, network device, gateway, etc.
(2) The adjacent node or nodes to which “this” node is connected, e.g., if node 1 is a virtual machine with a connection to node 4 which is a network, this is included in the training data set 212, as shown.
(3) The total number of connections into and out of “this” node.

The labels that are supplied during training for each node are the X and Y coordinates on the canvas. However, this is just an example. The labels may be visual representations based on node type, connection length, etc.

As noted above, the network visualization generator 122 may be a neural network model created in an ML library such as TensorFlow or PyTorch. The neural network is trained on pre-existing network topology diagrams embodied by the training data set 212. The training phase 210 may involve, at 220, transforming the training data set 212 into network features 222. The network features 222, which are extracted from the training data set 212, may be embedded into feature vectors. Feature vectors may include a sorted index, a type of the device, and connection indices. For example, the network features 222 may be embedded into feature vectors of [1.4, 2,0,0,0,0,0], [2.2, 3,0,0,0,0,0], etc. In other words, the training data set 212 is encoded as a sorted multidimensional array of the types of network nodes, and their connected nodes, forming the network features 222, and correlated x and y coordinates represented by labels 214, on a topology diagram canvas in a two dimensional space. That is, a multidimensional array 223 is generated in which device types and connection information are correlated with location labels. Inferences of appropriate topology layouts are made by predicting x, y coordinates given the encoded input features of a diagram under test, using the neural network model that takes into account of human expertise and habits in the placing of nodes in a network topology diagram. This is just an example. The neural network may further generate label vectors for node representations, connection types and lengths, etc. In addition to label vectors, the neural network may further generate additional feature vectors such as operating system vectors, hardware device type of node vectors, and node representation vectors.

The ML or AI model (the neural network) is trained to accurately predict labels 214 by encoding the training data set 212 into the multidimensional array 223 of network features 222, which include a plurality of devices types and connection information correlated with a plurality of location labels. The neural network is iteratively trained based on the multidimensional array 223 to accurately predict labels 214. Specifically, at 224, the neural network maps the network features 222 to the labels 214. Additionally, at 226, a training determination is made indicative of whether the plurality of predictions, generated by the neural network, match the plurality of location labels in the training data set 212 and at 228, the training determination is provided to the neural network to iteratively adjust the predictions to match or map onto the location coordinates in the training data set 212. That is, based on making the training determination that predictions do not match location labels in the training data set 212, the neural network is iteratively adjusted or updated until the neural network makes a training determination that the predictions match or substantially match location labels in the training data set 212. In one instance, the training is minimizing the average distance between the predicted locations and the locations provided in the training data at each iteration and the output locations may not necessarily exactly match at the end of training.

Moreover, the network visualization generator 122 may further be trained to avoid a visual overlap among network components on the canvas in the network visualization. This may be advantageous over existing software tools because the network visualization generator 122 learns to mimic human behavior, which often differs in the network domain from a strictly mathematical view of a network topology in which a set of nodes and connections are placed on the canvas without any further semantic value. By mimicking human behavior, the network visualization generator 122 provides semantic value in placing various components on the canvas to represent devices of a network.

The network visualization generator 122 is trained to mimic and resemble habits of network engineers, for example, with respect to placing nodes and representing nodes on a topology diagram canvas. By training the AI/ML model on examples designed by network engineers, the AI/ML model can use the same habits when inferring/predicting node locations and representations.

When the network visualization generator 122 has been trained on a sufficient number of examples, then the network visualization generator 122 generates reasonable and accurate predictions for the labels 214, such as the x and y coordinates of new nodes (nodes which have not been previously encountered) in a topology canvas. Additionally, when the nodes are moved to the predicted coordinates, the generated network visualization mimics human behaviors in the resultant layout. In short, in the training phase 210, the network visualization generator 122 makes training determinations indicative of whether the plurality of predictions match the plurality of location labels in the training data set 212 and based on these training determinations, iteratively adjusts or updates the predictions for the labels 214.

In the operating phase 240, the plurality of predictions 242 are generated. Specifically, at 250, the network topology information 158 is transformed into network features 252. In other words, network features 252 are extracted based on the network topology information 158. The network features 252 may include, for each network device, a device type and connection information (including lengths) for the connections. The network features 252 may be embedded into feature vectors 254a-j.

At 256, the network visualization generator 122 predicts (using the trained neural network model), a location on the canvas for each network device and for the one or more connections, based on the embedded feature vectors 254a-j. In other words, the neural network model infers coordinates or location labels shown as the plurality of predictions 242. For example, using a multidimensional array of extracted network features, the neural network model tries to match the embedded feature vectors 254a-j with ones stored in the multidimensional array. Similarly, the network visualization generator 122 predicts a visual representation for each node, connection type and length.

Using the plurality of predictions 242, the network visualization generator 122 designs the network on the canvas. At 258, the network visualization generator 122 outputs a network visualization 260 such as the network visualization 140 shown in FIG. 1A and FIG. 1B. The network visualization 260 may be a network topology diagram that provides operating states indicative of a network problem that is to be solved. A user may interact with the network visualization 260 or a network controller may provide instructions to change configurations of one or more network devices to solve or resolve the network problem, and these configuration changes are reflected in an updated network visualization by changing a visual appearance or a location of one or more network device(s).

The network visualization generator 122 is further configured to track user interactions with the network visualization 260. In one instance, user adjusted locations are fed into a future phase of training, so they become part of a future training data set. In another instance, if the user moves one or more components (nodes) on the canvas, changes connection length or type, these user interactions are detected and fed back into the network visualization generator 122, using a feedback loop 262. In other words, in the operating phase 240, the network visualization generator 122 is continuously learning to output more accurate predictions by tracking interactions or changes being made to the network visualization 260. The feature vectors 254a-j are iteratively adjusted based on interactions with the network visualization 260 using the feedback loop 262. Based on these interactions, the multidimensional array that includes a plurality of device types and connection information correlated with a plurality of location labels, is updated.

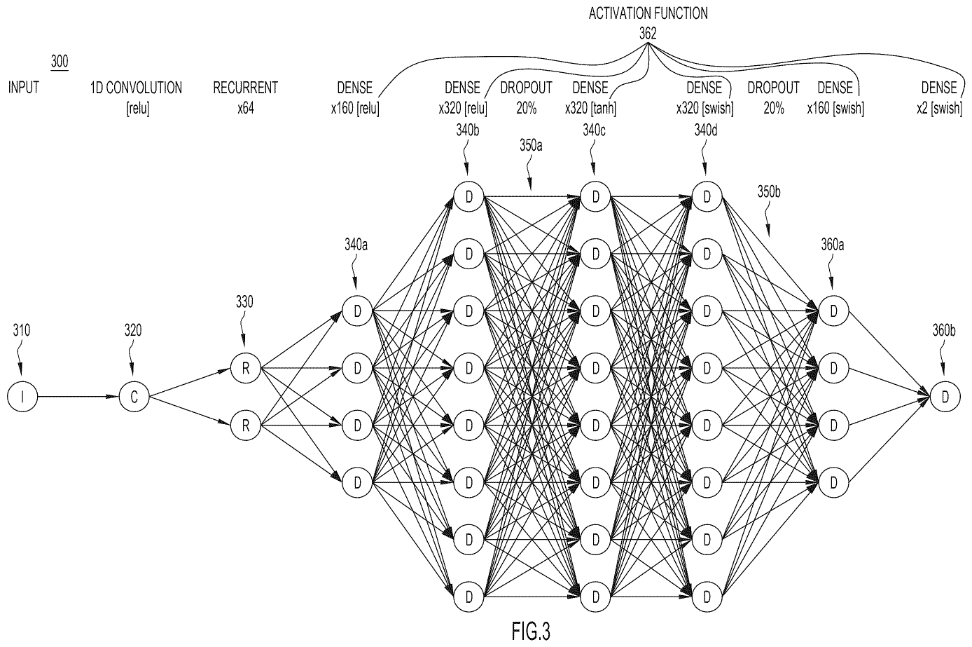

Reference is now made to FIG. 3, which illustrates components 300 of the network visualization generator 122 show in FIGS. 1A and 1B, according to an example embodiment. The network visualization generator 122 is an AI/ML model such as a neural network that includes an input layer 310, a convolution layer 320, a recurrent layer 330, a first plurality of dense layers 340a-d, a first dropout layer 350a and a second dropout layer 350b, and a second plurality of dense layers 360a-b.

In one instance, a neural network is a convolutional network that applies a sliding filter across the inputs and computes a sum of elements in the filter. As such, it reduces the amount of overall information in the signal to amplify features within the signal.

In particular, the input layer 310 is configured to receive input data such as the network topology information 158 of FIG. 1A. The input layer 310 matches the shape of the multidimensional array 223 in FIG. 2 and the output layer (a final dense layer) matches the shape of the multidimensional label array (labels 214 in FIG. 2).

The convolution layer 320 is configured to extract features from the input data by learning features or attributes of the network nodes in the network topology information 158. For example, the convolution layer 320 analyzes feature vectors and may average them to obtain a representation that consists of patterns that are common to inputs.

The recurrent layer 330 is configured to obtain sequences (feature vectors) from the convolution layer 320 and analyze values in the sequence to prevent overlap. The recurrent layer 330 may ensure that nodes on the canvas do not overlap one another but are spaced out based unevenly to mimic user placement. Specifically, the recurrent layer 330 maintains information from previous inputs and treats the input signal like a sequence. In this case, however, it is causing the AI/ML model to differentiate between nodes in the neural network that would otherwise have similar features (e.g., connected to the same components and being of the same type) as it emphasizes position in the input, and the nodes at different positions, but the same features, are generated with different labels being applied. By adding the convolution layer 320 and the recurrent layer 330 overlap among nodes are reduced and/or avoided.

The first plurality of dense layers 340a-d generate a plurality of coordinate predictions (labels for node placements). The first dropout layer 350a performs filtering by reducing the number of predictions generated. For example, 20% of unlikely predictions or coordinate labels are filtered out. Similarly, the second dropout layer 350b filters or reduces the number of predictions to avoid overlaps, for example. The second dropout layer 350b may further reduce the number of predicted coordinate labels by 20%. For example, the second dropout layer 350b may reduce predictions based on a number of connections and an identity for respective network devices. The second plurality of dense layers 360a-b generate predictions from the remaining prediction labels to output predicted coordinates for the nodes (e.g., x and y location).

A dense layer in each position within the model is the overall number of nodes and an activation function 362 is assigned to the layer. The activation function 362 is depicted in square brackets next to a layer type such as [relu], [tanh], [swish], etc. The first dropout layer 350a and the second dropout layer 350b are intended to prevent the model from overfitting to the training data by randomly removing some of the connections between the layers, as such the neural network is also applicable to newly encountered data/nodes.

For example, the table below depicts summary of tensor shapes and number of parameters of the components 300 of the neural network model shown in FIG. 3. This neural network model includes a mix of convolution, recurrent, dropout, and dense layers.

| Layer (type) | Output (shape) | Number of Parameters |
|---|---|---|
| Convolution layer 320 | (None, 60, 64) | 4, 224 |
| Recurrent layer 330 (GRU) | (None, 60, 64) | 24, 960 |
| Dense_6 layer 340a | (None, 60, 160) | 10, 400 |
| Dense_7 layer 340b | (None, 60, 320) | 51, 520 |
| First dropout layer 350a | (None, 60, 320) | 0 |
| Dense_8 layer 340c | (None, 60, 320) | 102, 720 |
| Dense_9 layer 340d | (None, 60, 320) | 102, 720 |
| Second dropout layer 350b | (None, 60, 320) | 0 |
| Dense_10 layer 360a | (None, 60, 160) | 51, 360 |
| Dense_11 layer 360b | (None, 60, 2) | 322 |

Numeric value “60” in the shape column of the table above depends on a number of features on the input (identity, number of connections, etc.). In this example, The numeric value “60” represents a maximum number of nodes for the neural network. But this is just an example. In another instance, the shape may have a numeric value “320” times the maximum number of nodes. The AI model may be tuned using the maximum nodes for smaller or bigger diagrams.

Analogous machine learning may be performed for other attributes or features such as node types or identities, connection lengths, and placements, using a mix of these layers. The components 300 are a mix of layers of a neural network model that output predictions for each node on the canvas. In one example embodiment, the mix of these layers may vary depending on predictions to be made.

While the components 300 describe a neural network model, the disclosure is not limited to using a neural network model with this mix of layers. Other ML/AI models may be used to generate predictions, such as a large language model (LLM), generative pre-trained transformers, etc.

Moreover, in one or more example embodiments, the network visualization generator 122 may obtain network topology information that includes an entire network design (multiple network devices, connection layers, etc.) and generate the network visualization. The network visualization generator 122 may obtain a change to the network design, such as an added/edited/deleted device or connection, and revise the network visualization based on the change. In other words, it is convenient for users to make changes to a network visualization because the network visualization generator 122 generates a new network visualization on the fly without any manual shifting/moving of nodes on the canvas.

Unlike the standard graph layouts, the network visualization generator 122 generates network visualizations that are subjectively closer to the way a user would select to layout a network topology. Moreover, unlike mathematically driven “even spread” approaches, the network visualization generator 122 accounts for user specific, expert specific, and/or enterprise specific design methodologies. That is, the network visualizations include connected network components on the canvas that are unevenly spaced apart and/or clustered together, to resemble the user specific placement.

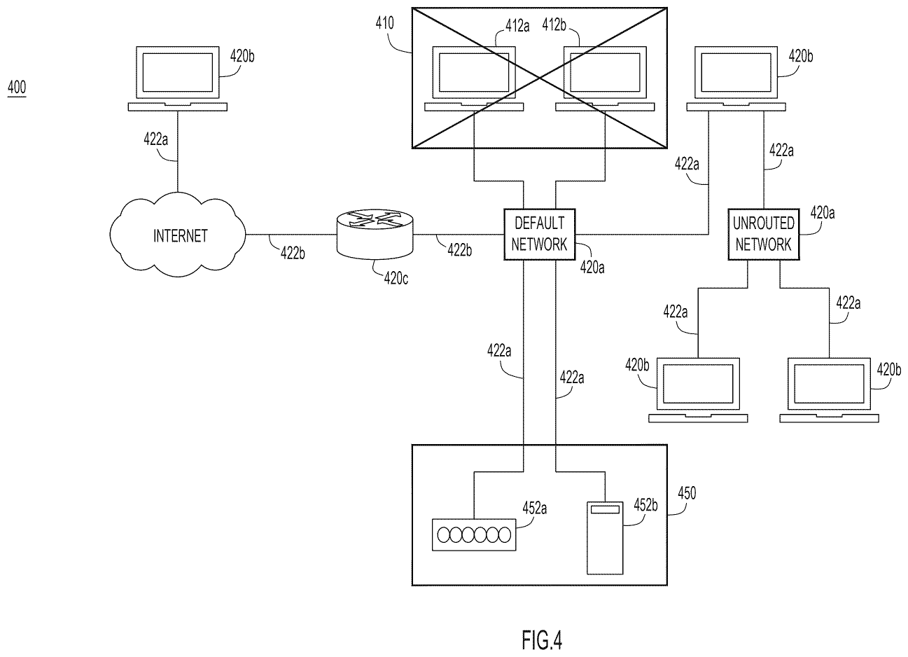

Reference is now made to FIG. 4, which is a comparative view illustrating the network visualization generator 122 generating a network topology diagram 400 in which a few network components are visually represented and placed at locations that resemble user behavior using techniques presented herein as opposed to representations and locations for these network components using conventional techniques.

The network topology diagram 400 includes nodes types 420a-420c, which represent certain types of connected network infrastructure (both physical and virtual). Examples of these node types are a virtual local access network (VLAN) 420a, a virtual machine (VM) 420b, and a hardware network device 420c such as a switch or a router. Nodes of various node types may be connected to each other via connections, which are representations of network connections 422a and 422b. For example, the VM 420b is connected to VLAN 420a via a first connection 422a and the hardware network device 420c is connected to the VLAN 420a via a second connection 422b. These representations are provided by way of an example only and not by way of a limitation.

In the network topology diagram 400, a first red box 410 represents a first VM type node 412a and a second VM type node 412b being added to the network topology diagram 400, according to conventional techniques. In the first red box 410, these nodes and connections are logically grouped and spread out close to the networks to which they are attached. If there is no deliberate layout selected, as the user adds nodes, these nodes are stacked up on top of each other, that is, placed in the same default location. The user has to use a mouse or other pointing device to physically drag the nodes to different locations on the canvas in order to spread them out. Typically, graphing libraries and tools use a layout algorithm such as “force-directed” to mathematically calculate the layout with the most even spread that avoids excessive overlapping. This results in a very spread out graph, as shown in the first red box 410. That is, adding two VMs, results in the nodes and connections being evenly spaced apart, as shown in the first red box 410. The first VM type node 412a, the second VM type node 412b, and the VM 420b are spaced at even angles around a default network such as the VLAN 420a (even spread).

On the other hand, the network visualization generator 122 generates the network topology diagram 400 in which the two added VMs mimic user specific placement and visual representation, shown in a second red box 450. In the second red box 450, a first VM type node 452a and a second VM type node 452b are placed below a default network using user specific icons for VM type nodes and at locations that are unevenly spread out. That is, users have particular habits when laying out network diagrams. Users may not like to spread out nodes evenly at even angles around a central point, as in the first red box 410. Instead, while the VMs may be clustered above, below or around a network, they are not spread out evenly. Instead, the VMs tend to be aligned horizontally or vertically. As such, the network visualization generator 122 learns this behavior and mimics it, as shown in the second red box 450. Specifically, the first VM type node 452a and the second VM type node 452b in the second red box 450 are clustered together to resemble user specific placement.

As such, it is easier for users to manage networks and run simulations using the network visualization generator 122. The network topology diagram 400 may provide operating state indicators indicative of a network problem in network device(s). A user may manipulate graphical elements in the network topology diagram 400 to change the configuration of the network device(s) to solve the network problem. The network topology diagram 400 may further be updated to indicate that the network problem is resolved by changing a visual appearance and/or a location of the network device(s). Since the network topology diagram 400 resembles user behavior in depicting operating states, appearances of failed devices, etc., the users may quickly assess and fix network problem(s).

While the network topology diagram 400 depicts connected network components, components may be unconnected, which further illustrates that force-directed algorithms discussed above may be unsuitable for diagram layouts.

The techniques presented herein generate network visualization(s) such as network diagrams and network topology graphs in which placement and representation of network components are predicted by an artificial intelligence (AI) or machine learning (ML) model to resemble users' behavior in a design process. The network visualization generator is trained by encoding a training data set into a multidimensional array (feature vectors having devices types and connection information correlated with location labels) and making a training determination indicative of whether the predictions match location labels in the training data set. The training determinations are used to iteratively adjust the predictions, that is, tune the network visualization generator.

The techniques presented herein generate network visualizations that may be used for resolving or solving network problems, troubleshooting, and/or running network simulations in which visual appearances of devices, apparatuses and/or connections may be updated based on user's behavior. In other words, the network visualizations resemble user behavior in visual appearances and placements of devices and connections.

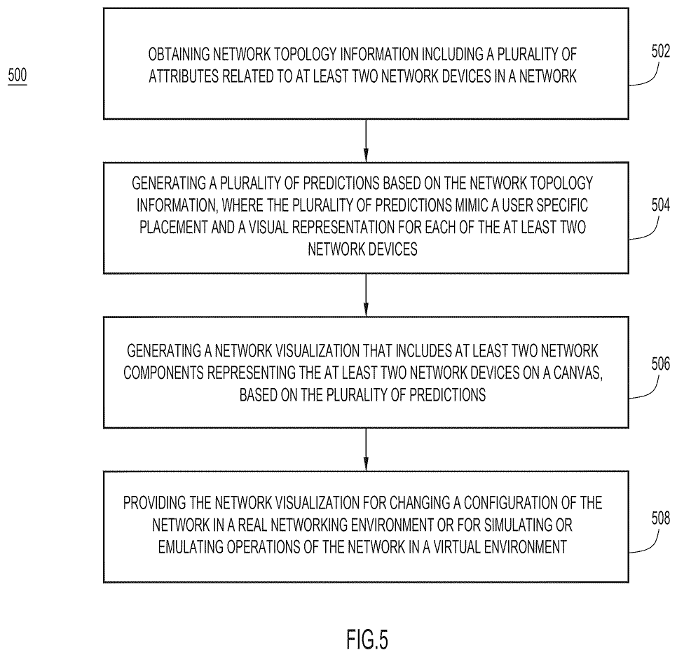

FIG. 5 is a flowchart illustrating a method 500 of generating and providing a network visualization for changing a configuration of the network in a networking environment, according to an example embodiment. The method 500 may be performed by a computing device such as a server or a group of servers or by a controller, such as the controller 120 of the network system 110, as shown in FIG. 1A.

The method 500 involves, at 502, obtaining network topology information including a plurality of attributes related to at least two network devices in a network.

The method 500 further involves at 504, generating a plurality of predictions based on the network topology information. The plurality of predictions mimic a user specific placement and a visual representation for each of the at least two network devices.

The method 500 further involves at 506, generating a network visualization that includes at least two network components representing the at least two network devices on a canvas, based on the plurality of predictions.

The method 500 further involves at 508, providing the network visualization for changing a configuration of the network in a real networking environment or for simulating or emulating operations of the network in a virtual environment.

According to one or more example embodiments, the network visualization may include a plurality of connected or unconnected network components on the canvas. The plurality of connected network components may be unevenly spaced apart and/or clustered together on the canvas, to resemble the user specific placement.

In one form, the plurality of predictions may further mimic the user specific placement of one or more connections between the at least two network components and a user specific length of the one or more connections.

In one instance, the operation 504 of generating the plurality of predictions may include determining the user specific placement for each of the at least two network devices based on a number of connections and an identity for a respective network device.

In another instance, the operation 504 of generating the plurality of predictions may include extracting a plurality of network features based on the network topology information. The plurality of network features may include, for each of the at least two network devices, a device type and connection information for the one or more connections. The operation 504 of generating the plurality of predictions may further include embedding the plurality of network features to form a plurality of feature vectors and predicting, using a neural network, a location on the canvas for each network device and for the one or more connections, based on the plurality of feature vectors.

According to one or more example embodiments, the neural network may predict the location using a mix of a convolutional layer, a recurrent layer, a dropout layer, and a dense layer.

In one form, the plurality of predictions may be generated by performing machine learning using a neural network. Additionally, the method 500 may further include obtaining a training data set that includes a plurality of visual representations that are designed by a user and encoding the training data set into a multidimensional array. The multidimensional array may include a plurality of features having a plurality of devices types and connection information correlated with a plurality of location labels. The method 500 may further involve training the neural network based on the multidimensional array.

In one instance, training the neural network may include making a training determination indicative of whether the plurality of predictions, generated by the neural network, match the plurality of location labels in the training data set. Training the neural network may further include providing the training determination to the neural network to iteratively adjust the plurality of predictions generated by the neural network.

In yet another form, the operation 504 of generating the plurality of predictions by performing machine learning may include avoiding a visual overlap among the at least two network components on the canvas in the visual representation.

According to one or more example embodiments, the method 500 may further involve providing one or more operating state indicators on the network visualization indicative of a network problem in a first network device of the at least two network devices. The method 500 may further involve changing the configuration of the first network device to solve the network problem and updating the network visualization to indicate that the network problem is resolved by changing a visual appearance or a location of the first network device.

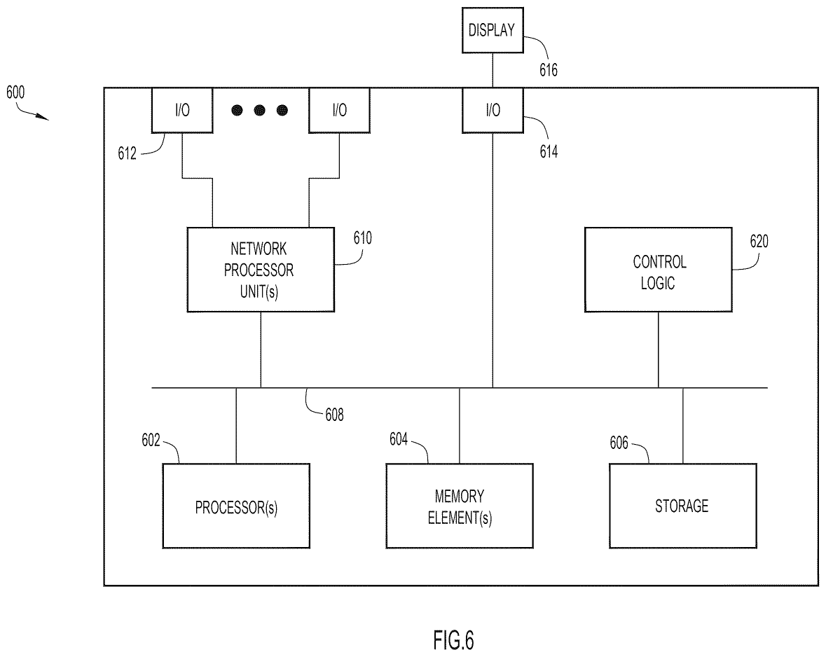

FIG. 6 is a hardware block diagram of a computing device 600 that may perform functions associated with any combination of operations in connection with the techniques depicted in FIGS. 1A, 1B, 2, 3, 4, and 5, according to various example embodiments, including, but not limited to, operations of the computing device or one or more servers that execute the network simulation and/or the apparatus. Further, the computing device 600 may be representative of one of the network devices, network/computing equipment, or hardware asset of an enterprise such as an access point, a client device, or an apparatus. It should be appreciated that FIG. 6 provides only an illustration of one example embodiment and does not imply any limitations with respect to the environments in which different example embodiments may be implemented. Many modifications to the depicted environment may be made.

In at least one embodiment, computing device 600 may include one or more processor(s) 602, one or more memory element(s) 604, storage 606, a bus 608, one or more network processor unit(s) 610 interconnected with one or more network input/output (I/O) interface(s) 612, one or more I/O interface(s) 614, and control logic 620. In various embodiments, instructions associated with logic for computing device 600 can overlap in any manner and are not limited to the specific allocation of instructions and/or operations described herein.

In at least one embodiment, processor(s) 602 is/are at least one hardware processor configured to execute various tasks, operations and/or functions for computing device 600 as described herein according to software and/or instructions configured for computing device 600. Processor(s) 602 (e.g., a hardware processor) can execute any type of instructions associated with data to achieve the operations detailed herein. In one example, processor(s) 602 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, one or more memory element(s) 604 and/or storage 606 is/are configured to store data, information, software, and/or instructions associated with computing device 600, and/or logic configured for memory element(s) 604 and/or storage 606. For example, any logic described herein (e.g., control logic 620) can, in various embodiments, be stored for computing device 600 using any combination of memory element(s) 604 and/or storage 606. Note that in some embodiments, storage 606 can be consolidated with one or more memory elements 604 (or vice versa), or can overlap/exist in any other suitable manner.

In at least one embodiment, bus 608 can be configured as an interface that enables one or more elements of computing device 600 to communicate in order to exchange information and/or data. Bus 608 can be implemented with any architecture designed for passing control, data and/or information between processors, memory elements/storage, peripheral devices, and/or any other hardware and/or software components that may be configured for computing device 600. In at least one embodiment, bus 608 may be implemented as a fast kernel-hosted interconnect, potentially using shared memory between processes (e.g., logic), which can enable efficient communication paths between the processes.

In various embodiments, network processor unit(s) 610 may enable communication between computing device 600 and other systems, entities, etc., via network I/O interface(s) 612 to facilitate operations discussed for various embodiments described herein. In various embodiments, network processor unit(s) 610 can be configured as a combination of hardware and/or software, such as one or more Ethernet driver(s) and/or controller(s) or interface cards, Fibre Channel (e.g., optical) driver(s) and/or controller(s), and/or other similar network interface driver(s) and/or controller(s) now known or hereafter developed to enable communications between computing device 600 and other systems, entities, etc. to facilitate operations for various embodiments described herein. In various embodiments, network I/O interface(s) 612 can be configured as one or more Ethernet port(s), Fibre Channel ports, and/or any other I/O port(s) now known or hereafter developed. Thus, the network processor unit(s) 610 and/or network I/O interface(s) 612 may include suitable interfaces for receiving, transmitting, and/or otherwise communicating data and/or information in a network environment.

I/O interface(s) 614 allow for input and output of data and/or information with other entities that may be connected to computing device 600. For example, I/O interface(s) 614 may provide a connection to external devices such as a keyboard, keypad, a touch screen, and/or any other suitable input device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a display 616 such as a computer monitor, a display screen, or the like.

In various embodiments, control logic 620 can include instructions that, when executed, cause processor(s) 602 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

In another example embodiment, an apparatus is provided. The apparatus includes a memory, a network interface configured to enable network communications, and a processor. The processor is configured to perform a method including obtaining network topology information including a plurality of attributes related to at least two network devices in a network and generating a plurality of predictions based on the network topology information. The plurality of predictions mimic a user specific placement and a visual representation for each of the at least two network devices. The method may further involve generating a network visualization that includes at least two network components representing the at least two network devices on a canvas, based on the plurality of predictions and providing the network visualization for changing a configuration of the network in a real networking environment or for simulating or emulating operations of the network in a virtual environment.

In yet another example embodiment, one or more non-transitory computer readable storage media encoded with instructions are provided. When the media is executed by a processor, the instructions cause the processor to execute a method that includes obtaining network topology information including a plurality of attributes related to at least two network devices in a network and generating a plurality of predictions based on the network topology information. The plurality of predictions mimic a user specific placement and a visual representation for each of the at least two network devices. The computer readable storage media encoded with instructions that may further cause the processor to generate a network visualization that includes at least two network components representing the at least two network devices on a canvas, based on the plurality of predictions and to provide the network visualization for changing a configuration of the network in a real networking environment or for simulating or emulating operations of the network in a virtual environment.

In yet another example embodiment, a system is provided that includes the devices and operations explained above with reference to FIGS. 1-6.

The programs described herein (e.g., control logic 620) may be identified based upon the application(s) for which they are implemented in a specific embodiment. However, it should be appreciated that any particular program nomenclature herein is used merely for convenience, and thus the embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, the storage 606 and/or memory elements(s) 604 can store data, software, code, instructions (e.g., processor instructions), logic, parameters, combinations thereof, and/or the like used for operations described herein. This includes the storage 606 and/or memory elements(s) 604 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™ mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein, the terms may be used in a generic sense to include packets, frames, segments, datagrams, and/or any other generic units that may be used to transmit communications in a network environment. Generally, the terms reference to a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data, or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
obtaining network topology information including a plurality of attributes related to at least two network devices in a network;
generating a plurality of predictions based on the network topology information, wherein the plurality of predictions mimic a user specific placement and a visual representation for each of the at least two network devices;
generating a network visualization that includes at least two network components representing the at least two network devices on a canvas, based on the plurality of predictions; and
providing the network visualization for changing a configuration of the network in a real networking environment or for simulating or emulating operations of the network in a virtual environment.

2. The method of claim 1, wherein the network visualization includes a plurality of connected network components on the canvas, the plurality of connected network components being unevenly spaced apart and/or clustered together on the canvas, to resemble the user specific placement.

3. The method of claim 1, wherein the plurality of predictions further mimic the user specific placement of one or more connections between the at least two network components and a user specific length of the one or more connections.

4. The method of claim 3, wherein generating the plurality of predictions includes:
determining the user specific placement for each of the at least two network devices based on a number of connections and an identity for a respective network device.

5. The method of claim 3, wherein generating the plurality of predictions includes:
extracting a plurality of network features based on the network topology information, wherein the plurality of network features include, for each of the at least two network devices, a device type and connection information for the one or more connections;
embedding the plurality of network features to form a plurality of feature vectors; and
predicting, using a neural network, a location on the canvas for each network device and for the one or more connections, based on the plurality of feature vectors.

6. The method of claim 5, wherein the neural network predicts the location using a mix of a convolutional layer, a recurrent layer, a dropout layer, and a dense layer.

7. The method of claim 1, wherein the plurality of predictions are generated by performing machine learning using a neural network, and the method further comprising:
obtaining a training data set that includes a plurality of visual representations that are designed by a user;
encoding the training data set into a multidimensional array that includes a plurality of features having a plurality of devices types and connection information correlated with a plurality of location labels; and
training the neural network based on the multidimensional array.

8. The method of claim 7, wherein training the neural network includes:
making a training determination indicative of whether the plurality of predictions, generated by the neural network, match the plurality of location labels in the training data set; and
providing the training determination to the neural network to iteratively adjust the plurality of predictions generated by the neural network.

9. The method of claim 1, wherein generating the plurality of predictions by performing machine learning including:
avoiding a visual overlap among the at least two network components on the canvas in the visual representation.

10. The method of claim 1, further comprising:
providing one or more operating state indicators on the network visualization indicative of a network problem in a first network device of the at least two network devices;
changing the configuration of the first network device to solve the network problem; and
updating the network visualization to indicate that the network problem is resolved by changing a visual appearance or a location of the first network device.

11. An apparatus comprising:
a memory;
a network interface configured to enable network communications; and
a processor, wherein the processor is configured to perform a method comprising:
obtaining network topology information including a plurality of attributes related to at least two network devices in a network;
generating a plurality of predictions based on the network topology information, wherein the plurality of predictions mimic a user specific placement and a visual representation for each of the at least two network devices;
generating a network visualization that includes at least two network components representing the at least two network devices on a canvas, based on the plurality of predictions; and
providing the network visualization for changing a configuration of the network in a real networking environment or for simulating or emulating operations of the network in a virtual environment.

12. The apparatus of claim 11, wherein the network visualization includes a plurality of connected network components on the canvas, the plurality of connected network components being unevenly spaced apart and/or clustered together on the canvas, to resemble the user specific placement.

13. The apparatus of claim 11, wherein the plurality of predictions further mimic the user specific placement of one or more connections between the at least two network components and a user specific length of the one or more connections.

14. The apparatus of claim 13, wherein the processor is configured to generate the plurality of predictions by determining the user specific placement for each of the at least two network devices based on a number of connections and an identity for a respective network device.

15. The apparatus of claim 13, wherein the processor is configured to generate the plurality of predictions by:
extracting a plurality of network features based on the network topology information, wherein the plurality of network features include, for each of the at least two network devices, a device type and connection information for the one or more connections;
embedding the plurality of network features to form a plurality of feature vectors; and
predicting, using a neural network, a location on the canvas for each network device and for the one or more connections, based on the plurality of feature vectors.

16. The apparatus of claim 15, wherein the neural network predicts the location using a mix of a convolutional layer, a recurrent layer, a dropout layer, and a dense layer.

17. One or more non-transitory computer readable storage media encoded with software comprising computer executable instructions that, when executed by a processor, cause the processor to perform a method including:
obtaining network topology information including a plurality of attributes related to at least two network devices in a network;
generating a plurality of predictions based on the network topology information, wherein the plurality of predictions mimic a user specific placement and a visual representation for each of the at least two network devices;
generating a network visualization that includes at least two network components representing the at least two network devices on a canvas, based on the plurality of predictions; and
providing the network visualization for changing a configuration of the network in a real networking environment or for simulating or emulating operations of the network in a virtual environment.

18. The one or more non-transitory computer readable storage media according to claim 17, wherein the network visualization includes a plurality of connected network components on the canvas, the plurality of connected network components being unevenly spaced apart and/or clustered together on the canvas, to resemble the user specific placement.

19. The one or more non-transitory computer readable storage media according to claim 17, wherein the plurality of predictions further mimic the user specific placement of one or more connections between the at least two network components and a user specific length of the one or more connections.

20. The one or more non-transitory computer readable storage media according to claim 19, wherein the computer executable instructions cause the processor to generate the plurality of predictions by:
determining the user specific placement for each of the at least two network devices based on a number of connections and an identity for a respective network device.
